(19) United States
(12) Patent Application Publication
(10) Pub. No.: US 2003/0169804 A1
(43) Pub. Date: Sep. 11, 2003

(54) Method of labelling a multi-frequency signal

(76) Inventors: Panos Kudumakis, London (GB); Stathis Voukelatos, Middlesex (GB)

Correspondence Address: Martin Fleit, Fleit Kain Gibbons Gutman & Bongini, 601 Brickell Key Drive #404, Miami, FL, 33131, US

(21) Appl. No.: 10/182,583

(22) PCT Filed: Feb. 2, 2001
(86) PCT No.: PCT/GB01/00413

(30) Foreign Application Priority Data
Feb. 2, 2000 (GB) 0002259.0

(51) Int. Cl. H04B 1/69

(52) U.S. Cl. 375/143; 375/240.01

(57) ABSTRACT

A system for labelling and subsequently identifying a multi-frequency signal, includes means for inserting a code signal into a multi-frequency signal, signal distribution means, signal receiving means, code extraction means, and monitoring means to determine which parts of the frequency spectrum will at least partly mask the code signal at a given time using predetermined criteria. The means for inserting a code signal includes means for eliminating one or more frequency ranges being located in a part of the frequency spectrum that will at least partly mask the code signal, the location of the frequency ranges being eliminated from the said multi-frequency signal varies with the frequency content of said multi-frequency signal.

This invention relates to a method of labelling a multi-frequency signal, and particularly, though not exclusively, to a method of labelling an audio or video signal prior to broadcast or distribution to provide an audit trail. It also relates to a system for labelling such a signal and a system for controlling replay of such a signal.

A known method of labelling or watermarking a plural channel audio signal is disclosed in WO96/21290. Although the technology was initially targeted at the broadcast monitoring field, there are a number of other application areas where it can be employed. These include: digital television systems, streaming audio over the Internet, and digital audio distribution. The system provides a method of labelling an audio signal by embedding an identifying code inaudibly within the signal. The code can be used for identifying copyright ownership, fingerprinting and access control to digital audio data. Two notches are inserted in the audio band to provide frequencies at which the code may be inserted. The code signal is inserted as a series of pulses at the centre frequencies of the notches, and insertion is initiated when the program content provides sufficient masking conditions for the code to be inserted inaudibly. A masking filter is employed to determine the masking level of the incoming signal at the chosen code frequencies. The level of unwanted signal breakthrough in the notch frequencies is also monitored as it can prevent correct extraction of the code. Whilst this process is in progress, if either level falls below a pre-determined value the code generation is abandoned. Thus, the codes are inserted as often as the input signal conditions allow.

The technique can be applied to both mono and stereophonic signals. The code is inserted in both channels simultaneously in a way that gives monophonic compatibility for coded stereo signals. The system, however, has a potential security problem as an attacker can filter out the code by the use of narrow notch filters operating at the same frequencies as used at the original encoding process. To enhance the security of the system, U.S. Pat. No. 5,113,437 discloses implementing frequency hopping, by allowing the encoder to switch randomly between three predetermined notch frequency pairs. In order to decode the signal it is necessary to provide three decoders connected in parallel, each decoder being responsive to one of the three notch frequency pairs. Another method of inserting a code in one or more frequency components of an audio signal is disclosed in U.S. Pat. No. 5,450,490.

According to a first aspect of the invention there is provided a method as specified in claims 1 -10.

According to a second aspect of the invention there is provided a system as specified in claim 11,

According to a third aspect of the invention there is provided a system as specified in claim 12.

According to a further aspect of the invention there is provided a signal as specified in claim 13.

Embodiments of the invention will now be described, by way of example only, with reference to the accompanying schematic drawings in which:—

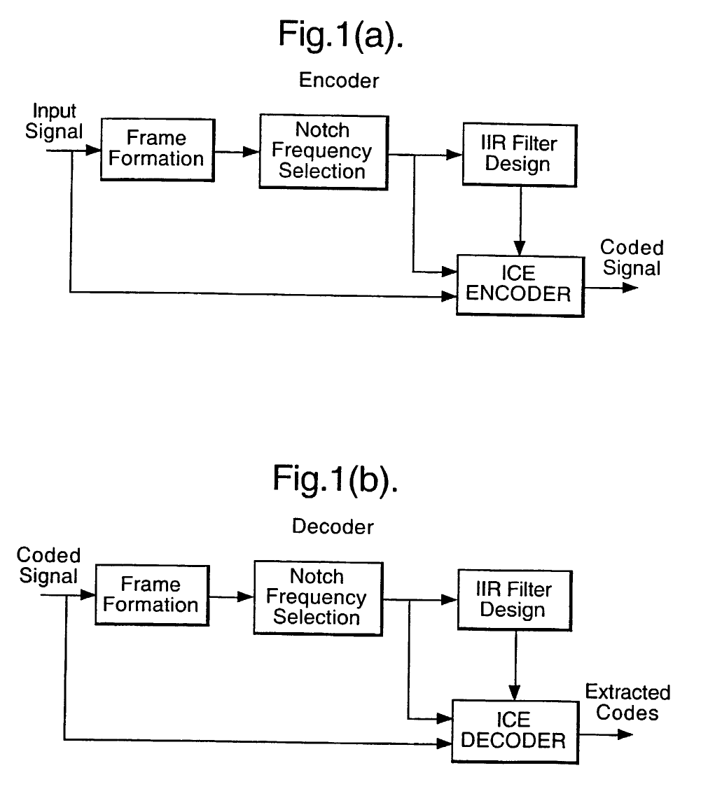

FIG.1 shows a schematic diagram of an embodiment of the invention,

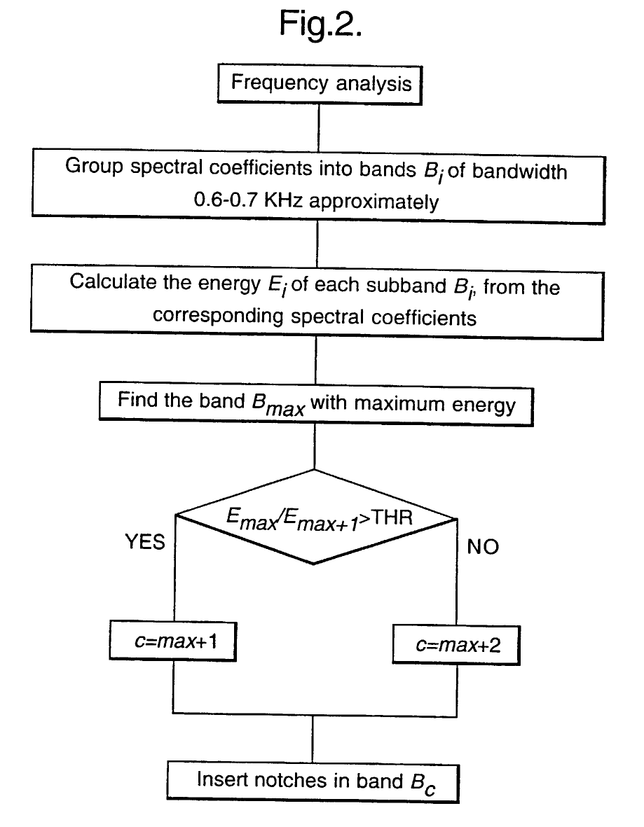

FIG. 2 shows a flow diagram of an embodiment of the invention, and

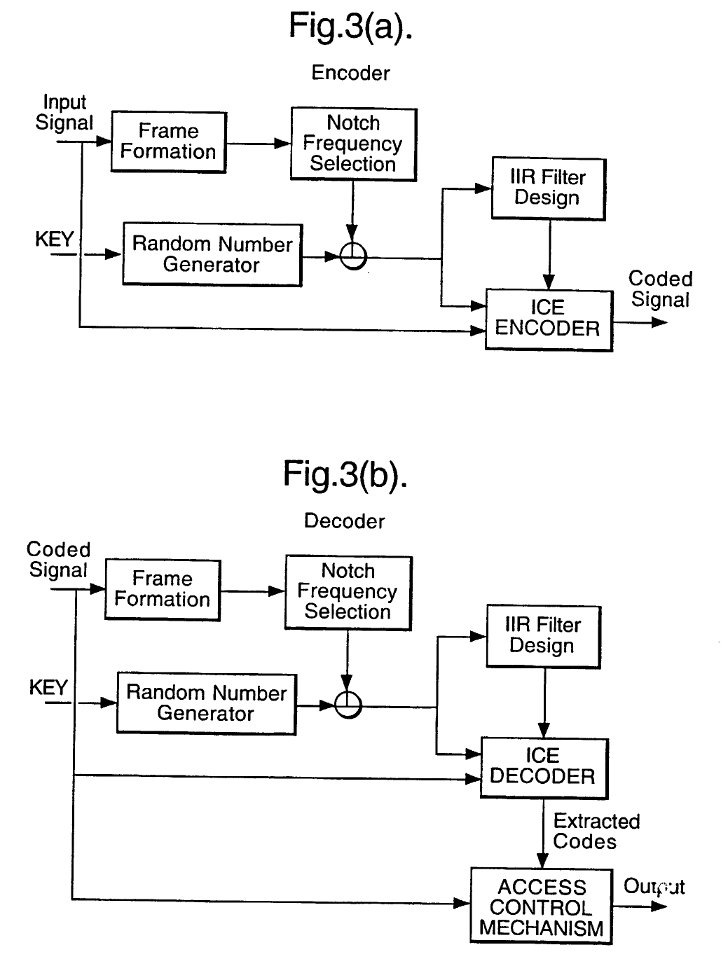

FIG. 3 shows a schematic diagram of a second embodiment of the invention.

The present invention includes a method for appropriately selecting the part of the frequency spectrum where each watermark code is inserted, providing improved audio quality and extra security in the form of frequency hopping. The method described may be been implemented in software.

The present invention differs from prior art systems in that the selection of the location of the notch or notches in the frequency spectrum of a signal (and hence the frequency of the embedded code) is chosen adaptively with regard to the frequency content of the signal (with the possible addition of a random offset). Moreover, in general it does not require the existence of a decoder array for all the possible notch frequency values in order to extract the codes, although use of such an array is not precluded.

The placement of the notch frequencies plays a significant role to the subjective quality of the coded signals. The codes are more perceptible if the notch frequencies coincide with the main frequency component of the signal. On the other hand, they have to be placed in a part of the spectrum with sufficient energy so that frequent masking conditions can be met. Therefore, a criterion that satisfies these requirements is needed for the selection of the code frequencies.

In one embodiment, the method comprises the following elements:

Segmentation of the input signals into frames and transformation into the frequency domain (unless the input signal is already in this form).

Selecting the appropriate notch frequency location for each frame according to a predetermined criterion.

Adapting the encoder and decoder filter parameters to the selected notch frequencies.

Adding a degree of randomness or unpredictability in determining the precise location of the notch frequencies.

The integration of these main elements of the invention to the encoder and decoder of WO96/21290 is illustrated in the block diagram of FIG. 1.

The input signal is digitized and processed in frames. Once a frame of samples has been assembled, the notch frequency selection criterion is applied to determine the position of the notch frequencies. The function of the criterion is illustrated in FIG. 2. A frequency analysis technique, e.g. FFT, is applied to generate a set of spectral coefficients. The spectral coefficients are grouped to form frequency bands of approximate width 0.6-0.7 kHz. The energy content of each band is calculated from the corresponding spectral coefficients. The band with the maximum energy content is found. This process up to here can use part of the psycho-acoustic modeling performed by an MPEG encoder. The notch frequencies are placed in one of the two neighboring bands, as illustrated in the flow diagram of FIG. 2. This Figure shows that when the band with maximum energy in it is determined (B_{max′} the code is either placed in the nearest neighbour band Bₘₐₓ₊₁ if the energy peak is narrower than some threshold value, or placed in the second nearest neighbour band Bₘₐₓ₊₂ if the energy peak is broad.

Changing the position of the notch frequencies during the encoding process involves the employment of a new filter set that will be responsive to the new frequency values. Since the set of possible values that the notch frequencies can take is large and depends upon the signal content, using a pre-computed set of filters for each possible notch frequency value is not practical and would increase significantly the memory requirements of the system. Therefore, it is more efficient to design the new filter set in real time every time the position of the notches is changed. The band-pass and band-stop filters are designed by applying a frequency transformation to a prototype low-pass filter, as described for example in the book “Introduction to Digital Signal Processing”, by J. G. Proakis and D. G. Manolakis, Maxwell Macmillan International Editions (1989). By applying the appropriate frequency transformation to a 4^{th}-order IIR prototype low-pass filter 8^{th}-order band-pass and band-stop filters are generated. Thus, only one filter set corresponding to the current notch frequency values needs to be stored at any given time.

The notch frequency selection and filter design process are applied in an identical fashion during the decoding of a signal, as shown in FIG. 1(b). The decoder is able to reproduce the same sequence of notch frequencies with the encoder and extract the codes from the signal, unless significant distortion has been introduced to the signal spectrum.

A second way to locate the best place to insert the notch filters will now be described. For each input block, a search is performed for the fundamental and harmonics of the input audio stream. Methods such as Fast Fourier Transform, Cepstrum, Correlogram or the Gold-Rabiner algorithm can be used to find both the fundamental and its harmonics. The notch filters can be inserted in the upper or lower edges of these harmonics (with the possible addition of a random offset). Care must be taken to ensure the insertion is not audible. This can be achieved, for example, using the psycho-acoustic model.

In addition to improved audio quality, security against malicious attacks, that would attempt to remove the codes by inserting notches to the coded signal, is enhanced. If the code frequencies change frequently, then it becomes more difficult for an attacker to remove all the codes without introducing significant distortion to the original signal content by removing many notches all the time. The security of the system can be enhanced by adding some randomness to the selection of the notch frequencies. This is illustrated in FIG. 3, in the context of an access control application. Detection of the codes is possible only if the decoder is provided with the (secret) key. The access control mechanism will allow playback of the audio signal only if the correct codes are extracted.

The present invention can provide the following advantages:—

a) Improved audio quality through adapting the notch frequency selection to the input signal content.

b) Enhanced security against malicious attacks.

Whilst the high decoding performance of the original audio watermarking algorithm is maintained.

Of course, the code is not inserted continuously into the signal—the signal is constantly monitored to check that the frequency content of the signal can mask the code, and insertion is not performed if the program content changes so that the code would become more easily audible. This can be done using the psycho-acoustic model as used by the MPEG encoding process, or the fundamental and harmonics method as described above or by the frequency analysis described in WO96/21290. If there is not a long enough “window of opportunity” to insert the entire code sequence in a single step, it is of course possible to cut the code up into shorter lengths and insert each part in succession, preferably sending a few bits of data at either end of the portion of code telling the decoder how much code is being sent or where the next length is to start in terms of the entire code sequence. Amplitude or phase modulation of the code signal can be employed.

As a further refinement, data telling the decoder where notches are going to be inserted, or the filter coefficients corresponding to these notches (and/or data telling the decoder how much code is being sent or where the next length is to start in terms of the entire code sequence) can be sent via a different channel. For example, the MPEG-4 IPMP framework includes an IPMP data stream which can be used for the transmission of any private data (such as the notch frequencies) from the encoder to the decoder (for a full description of this see for example “MPEG-4 Intellectual Property Management and Protection (IPMP) Overview & Applications Document MPEG/N2614, Rome December 1998, http:/ /www.cselt.it/mpeg/public/w2614.zip).

The data, such as the notch frequencies or the filter coefficients corresponding to these notch frequencies, transmitted using the IPMP data stream from the encoder to the decoder, may be encrypted, in order to further improve security of an MPEG-4 terminal. A decryption key can be sent using the IPMP data stream, or using a different communication channel.

In this case, where the position of the notches is sent via a channel such as the IPMP data stream, the decoder does not need to run a psycho-acoustic model or other similar analysis to calculate the positions of the notch frequencies or the corresponding filter coefficients. Thus, this embodiment is more robust to signal processing which can alter the apparent frequency content of the signal between encoder and decoder, and can result in lower decoder complexity and cost.

Finally, GB 0002259.0, from which the present application claims priority, especially the diagrams, is incorporated herein by reference.

1. A method of labelling a multi-frequency signal including or consisting of a) eliminating one or more frequency ranges from said signal, b) inserting a code signal into said multi-frequency signal in the said one or more frequency ranges, the multi-frequency signal being monitored to determine which parts of the frequency spectrum will at least partly mask the code signal at a given time using one or more predetermined criteria, and that the said one or more frequency ranges being eliminated is/are located in a part of the frequency spectrum that will at least partly mask the code signal, characterised in that the location of the frequency ranges being eliminated from the said multi-frequency signal varies with the frequency content of said multi-frequency signal.

2. A method as claimed in claim 1 in which an optimum frequency for insertion of the code signal is determined, and the corresponding frequency range being eliminated is offset from said optimum frequency by a given amount, the given amount having an apparently random or pseudo-random or quasi-random nature and being capable of being predicted by a decoder having a suitable key.

3. A method as claimed in any preceding claim in which the multi-frequency signal comprises a video or audio signal.

4. A method as claimed in any preceding claim in which the multi-frequency signal comprises a compressed digital data stream.

5. A method as claimed in any preceding claim in which the method is performed in the frequency domain on a frame by frame basis.

6. A method of labelling a first multi-frequency signal, including or consisting of a) eliminating one or more frequency ranges from said first signal, b) inserting a code signal into said first signal in the said one or more frequency ranges, the said first signal being monitored successively to determine which parts of the frequency spectrum will at least partly mask the code signal at a given time using one or more predetermined criteria, the said one or more frequency ranges being eliminated being located in a part of the frequency spectrum that will at least partly mask the code signal, characterised in that the method is performed in the frequency domain on a frame by frame basis.

7. A method as claimed in any preceding claim in which the multi-frequency signal comprises a plural channel audio signal, and the code is inserted into a plurality of said channels simultaneously.

8. A method as claimed in any preceding claim in which the signal comprises an MPEG-4 data stream, and data specifying the position of the frequency ranges being eliminated is sent from the encoder to the decoder using the IPMP data channel.

9. A method as claimed in claim 2 in which the signal comprises an MPEG-4 data stream, and the said key is sent from the encoder to the decoder using the IPMP data channel.

10. A method as claimed in claim 8 in which the data specifying the position of the frequency ranges being eliminated is encrypted.

11. A system for labelling and subsequently identifying a multi-frequency signal, consisting of or including a means for inserting a code signal into a multi-frequency signal, signal distribution means, signal receiving means, code extraction means, and monitoring means to determine which parts of the frequency spectrum will at least partly mask the code signal at a given time using one or more predetermined criteria, the means for inserting a code signal including means for eliminating one or more frequency ranges being located in a part of the frequency spectrum that will at least partly mask the code signal, the location of the frequency ranges being eliminated from the said multi-frequency signal varying with the frequency content of said multi-frequency signal.

12. A system for controlling replay of a signal consisting of or including a means for inserting a code signal into a multi-frequency signal, signal distribution means, signal receiving means, code extraction means, and monitoring means to determine which parts of the frequency spectrum will at least partly mask the code signal at a given time using one or more predetermined criteria, the means for inserting a code signal including means for eliminating one or more frequency ranges being located in a part of the frequency spectrum that will at least partly mask the code signal, the location of the frequency ranges being eliminated from the said multi-frequency signal varying with the frequency content of said multi-frequency signal.

13. A signal labelled using a method as specified in claims 1-10.
